(19) United States
(12) Patent Application Publication
(10) Pub. No.: US 2024/0326871 A1
(43) Pub. Date: Oct. 3, 2024

(54) External Voice Valet (Parking And Summoning) For Semi-Autonomous And Automounts Vehicles

(71) Applicant: Panasonic Automotive Systems Company of America, Division of Panasonic Corporation of North America, PEACHTREE CITY, GA (US)

(72) Inventors: SACHIKO KOBAYASHI, NOVI, MI (US); KATHERINE JENNETTE FREUND, WIXOM, MI (US)

(21) Appl. No.: 18/623,115

(22) Filed: Apr. 1, 2024

Related U.S. Application Data
(60) Provisional application No. 63/456,114, filed on Mar. 31, 2023.

(51) Int. Cl. B60W 60/00; B60W 30/06; G10L 17/22

(52) U.S. Cl. CPC B60W 60/0025; B60W 30/06; G10L 17/22; B60W 2420/54

(57) ABSTRACT

A self-parking arrangement for an autonomous motor vehicle includes a vehicle driving system that causes the motor vehicle to travel to a chosen or desired location. A microphone is positioned to produce a microphone signal based on a sensed voice of a human who is disposed outside the motor vehicle. An automatic speech recognition system receives the microphone signal, interprets a command in the microphone signal, and transmits a second signal to cause the vehicle driving system to operate the motor vehicle in accordance with the command in the microphone signal.

### CROSS-REFERENCED TO RELATED APPLICATIONS

This application claims benefit of U.S. Provisional Application No. 63/456,114, filed on Mar. 31, 2023, the disclosure of which is hereby incorporated by reference in its entirety for all purposes.

### BACKGROUND OF THE INVENTION

### 1. Field of the Invention

The present invention relates to parking a motor vehicle that is capable of autonomous driving.

### 2. Description of the Related Art

Autonomous vehicles may be capable of automatic parking in response to the user manually activating a control inside the vehicle. An autonomous vehicle may also be capable of automatic parking and being summoned from a parking space in response to manual activation of a control on a phone app or a key fob. However, either the driver must be in the vehicle, or he must have access to another device, such as a phone or key fob.

### SUMMARY OF THE INVENTION

The invention may include an automotive system having at least one externally located microphone, automatic speech recognition (ASR) capability, and the ability to follow (e.g., understand and implement) specific oral directions from the user when self-parking, enabling the user to control the parked status of the vehicle from outside of the vehicle.

The user may issue a voice command to the vehicle, such as “Park my car” or “Parallel park here”. The command may be picked up by the external microphone(s), interpreted by the ASR system, analyzed in the cloud for personalization (e.g., identifying the human speaker), and sent to the self-park system.

The voice-activated vehicle control system of the invention enables the driver/occupants to control the vehicle from outside of the vehicle (L3+), thereby also enabling the driver to exit the vehicle before parking in a tight parking space where there is minimum room to open/close the door. This may be especially helpful for people with disabilities who may require more room to exit the vehicle. The inventive system can also summon the car out from a tight parking space to provide ample room for the driver and passengers to enter the car or load luggage in the back of the car when the vehicle is parked too closed to the wall or to another vehicle.

The inventive system may enable the driver to provide the vehicle with specific instruction for parking such as “Back into the parking space”

This inventive system may be helpful for a novice driver to park in a tight parking space and when parallel parking. The inventive system may also be helpful in inclement weather, such as rain or excessive cold, by providing the driver with more flexibility as to where they exit their vehicle. This system may also be helpful when the driver has large or heavy luggage to unload near a venue, and he would prefer to unload the luggage closer to a building entrance, or near an overhang or awning, for example.

The voice command parking of the invention may be seamless without the user having to access another device. Also, this inventive system may enable the user to provide numerous and specific commands such as “back up in the parking spot”, “park under the overhang”, or “park on the right side of the garage space”, for example.

The invention comprises, in one form thereof, a self-parking arrangement for an autonomous motor vehicle, including a vehicle driving system that causes the motor vehicle to travel to a chosen or desired location. A microphone is positioned to produce a microphone signal based on a sensed voice of a human who is disposed outside the motor vehicle. An automatic speech recognition system receives the microphone signal, interprets a command in the microphone signal, and transmits a second signal to cause the vehicle driving system to operate the motor vehicle in accordance with the command in the microphone signal.

The invention comprises, in another form thereof, a method for operating an autonomous motor vehicle, including producing a microphone signal based on a sensed voice of a human who is disposed outside the motor vehicle. A command in the microphone signal is interpreted. A signal is transmitted to cause the motor vehicle to be operated in accordance with the command in the microphone signal.

The invention comprises, in yet another form thereof, a self-parking arrangement for an autonomous motor vehicle. The arrangement includes a vehicle driving system that causes the motor vehicle to travel to a chosen or desired location. A microphone is positioned to produce a microphone signal based on a sensed voice of a human who is disposed outside the motor vehicle. An automatic speech recognition system receives the microphone signal, interprets a command in the microphone signal, and transmits the microphone signal to a remote computer. The automatic speech recognition system receives a second signal from the remote computer. The second signal includes an identification of the human and/or an authorization level of the human. The automatic speech recognition system transmits a third signal to cause the vehicle driving system to operate the motor vehicle in accordance with the command in the microphone signal. The third signal is dependent upon the identification of the human and/or the authorization level of the human.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a motor vehicle including an autonomous parking voice control arrangement of the present invention.

FIG. 2 is a flow chart of one embodiment of a method of the present invention for operating an autonomous motor vehicle.

FIG. 3 is a flow chart of another embodiment of a method of the present invention for operating an autonomous motor vehicle.

FIG. 4 is a flow chart of yet another embodiment of a method of the present invention for operating an autonomous motor vehicle.

FIG. 5 is a flow chart of a further embodiment of a method of the present invention for operating an autonomous motor vehicle.

FIG. 6 is a flow chart of still another embodiment of a method of the present invention for operating an autonomous motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

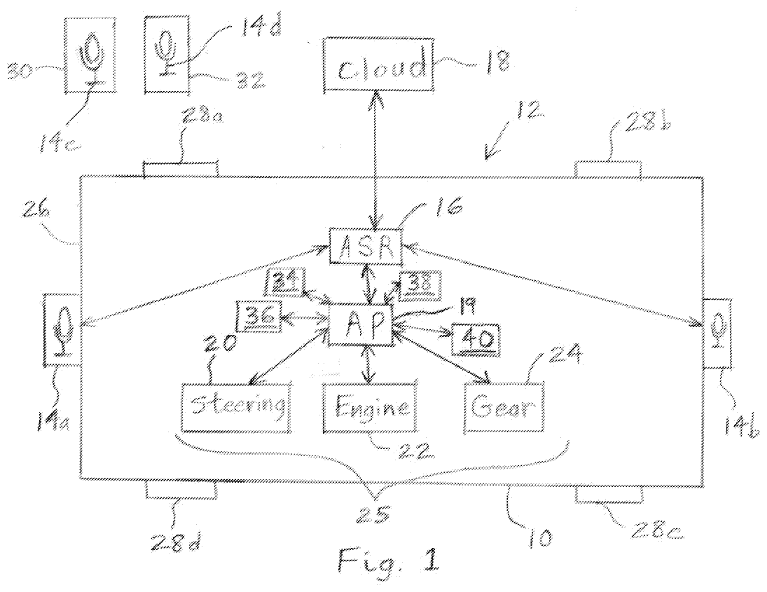

FIG. 1 illustrates one embodiment of a motor vehicle 10 including an autonomous parking voice control arrangement 12 of the present invention. Arrangement 12 includes two external microphones 14a-b in communication with an automatic speech recognition (ARS) system 16. System 16 is in wireless communication with cloud computers 18 that are outside of and disposed remote from vehicle 10. System 16 is also in communication with an autonomous parking system 19, which controls a wheel steering system 20, an engine or motor 22, and a gear system 24. Wheel steering system 20, engine or motor 22, and gear system 24 may be conjunctively referred to herein as a vehicle driving system 25. A vehicle driving system may generally include any component or system that causes vehicle 10 to travel to a chosen or desired location and/or any component or system that a human driver would conventionally control in a nonautonomous vehicle to cause the vehicle to travel to a chosen or desired location.

Microphones 14a-b may be mounted on an exterior of a body 26 of vehicle 10. Although microphones 14a-b are shown on the front and rear of vehicle 10 as an example, there may be any number of these external microphones, and they may be mounted anywhere on the exterior of vehicle 10. It is also possible for the microphones to be mounted within body 26 so long as they are able to pick up voice commands spoken outside of, and within an operational range of vehicle 10 (e.g., up to approximately between 50 and 100 feet away from the vehicle).

During use, ASR system 16 receives microphone signals based on voice commands spoken by the driver outside of vehicle 10 and sensed or picked up by microphones 14a-b. ASR system 16 may wirelessly transmit these received microphone signals to cloud computing resources 18 to identify the person who spoke the voice commands and to thereby confirm that he is the owner of vehicle 10 or otherwise authorized to control vehicle 10. If cloud computing 18 indicates the commands were not spoken by an authorized user, then ASR system 16 may ignore the commands. However, if cloud computing 18 indicates the commands were indeed spoken by an authorized user, then ASR system 16 may interpret the commands to determine their content (e.g., what commands have been spoken). After interpreting the commands, ASR system 16 may instruct autonomous parking system 19 accordingly as to where and how to park vehicle 10, or where to drive vehicle 10 to pick up the driver from the parking space that vehicle 10 is currently in.

After receiving instructions from ASR system 16, autonomous parking system 19 may control wheel steering system 20, engine 22, and a gear system 24 to park and/or drive vehicle 10 as instructed. Wheel steering system 20 may control the directions in which tires 28a-d are aligned or oriented. Engine 22, or motor 22 in the case of an electric vehicle, may provide power to drive the powertrain (not shown) of vehicle 10. Gear system 24 may control the gear that vehicle 10 is in, such as Park, Reverse, Drive, or Neutral, and thus may control the direction in which wheels 28a-d are driven by engine 22.

As described above the speech commands themselves are analyzed to determine an identity and authorization of the human speaker. In another embodiment, in addition to speech commands, the user's identity and/or permission level is verified via voice biometrics.

The user's voice has been described as being sensed by a microphone on the vehicle. In another embodiment, the user's voice command is picked up via a phone app (e.g., a microphone 14c on a mobile phone 30) and/or a microphone 14d embedded on a key fob 32 when the user is away from the vehicle. Microphone signals from either of microphones 14c-d may be wirelessly transmitted to ASR system 16. Information about the location of the user (e.g., the location of the phone or key fob) may be wirelessly sent to the cloud or to the vehicle as the command is sent to the cloud or to the vehicle.

In another embodiment, artificial intelligence learns the user's preferences regarding parking and leaving a parking space based on historical data. The vehicle can then perform the parking and the leaving of the parking space in ways that conform to the user's preferences, and without real time input from the user.

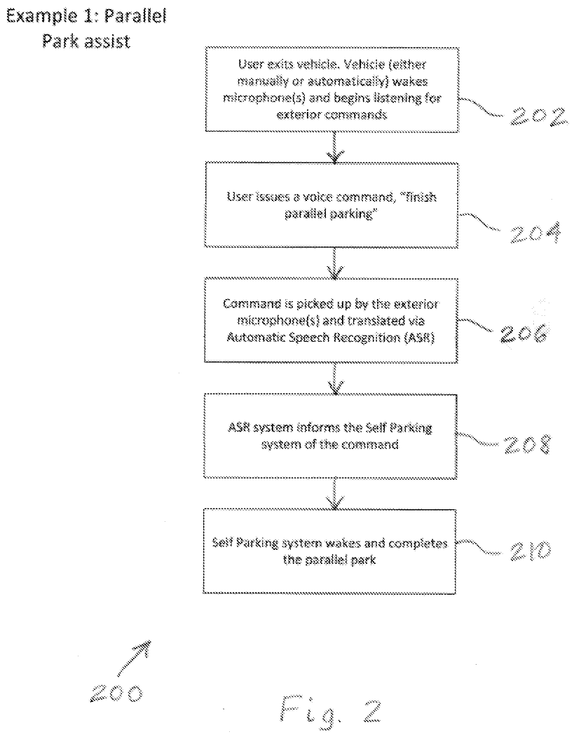

FIG. 2 illustrates one embodiment of a method 200 of the present invention for operating autonomous motor vehicle 10. In a first step 202, the user exits the vehicle. The vehicle wakes microphone(s) (either manually or automatically) and begins listening for exterior commands. For example, a driver may get out of vehicle 10, and ASR system 16 may sense key fob 32 leaving vehicle 10 and then begin listening to microphones 14a-b. Alternatively, the driver may actuate a switch (not shown) in vehicle 10 to cause ASR system 16 to begin listening to microphones 14a-b.

Next, in step 204, the user speaks/issues a voice command, “finish parallel parking”. In a next step 206, the spoken command is sensed/picked up by the exterior microphone(s) (e.g., microphones 14a-b) and translated or interpreted via Automatic Speech Recognition (ASR) system 16.

In step 208, ASR system 16 informs self-parking system 19 of the command. In a final step 210, self-parking system 19 wakes and completes the parallel parking task by use of vehicle driving system 25.

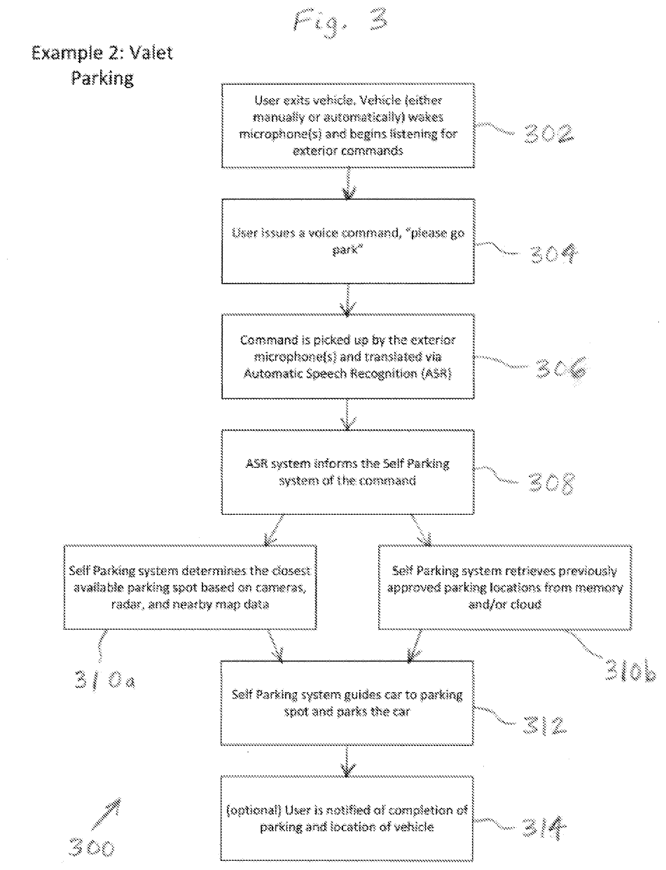

FIG. 3 illustrates another embodiment of a method 300 of the present invention for operating autonomous motor vehicle 10. In a first step 302, the user exits vehicle 10. Vehicle 10 then wakes microphone(s) 14a-b (either manually or automatically) and begins listening for exterior commands. For example, a driver may get out of vehicle 10, and ASR system 16 may sense key fob 32 leaving vehicle 10 and then begin listening to microphones 14a-b. Alternatively, the driver may actuate a switch (not shown) in vehicle 10 to cause ASR system 16 to begin listening to microphones 14a-b.

In a next step 304, the user speaks/issues a voice command, “please go park”. Next, in step 306, the command is picked up by the exterior microphone(s) (e.g., microphones 14c-d) and translated or interpreted via Automatic Speech Recognition (ASR) 16.

In step 308, ASR system 16 informs Self-Parking system 19 of the command. In a next step 310a, Self-Parking system 19 determines the closest available parking spot based on data received from cameras 34, radar system 36, and map data of the nearby area, which may be received from cloud computers 18.

As an alternative to step 310a, or in addition to step 310a, in step 310b Self-Parking system 19 retrieves previously approved parking locations from memory device 38 and/or from cloud computers 18.

Next, in step 312, Self-Parking system 19, having chosen a target parking spot from the parking spot(s) identified in steps 310a and/or 310b, guides and drives vehicle 10 to the target parking spot and parks the car. In a final step 314, the user is notified of the completion of the parking process and of the location of vehicle 10. The user may receive the notification via text message and/or email, for example.

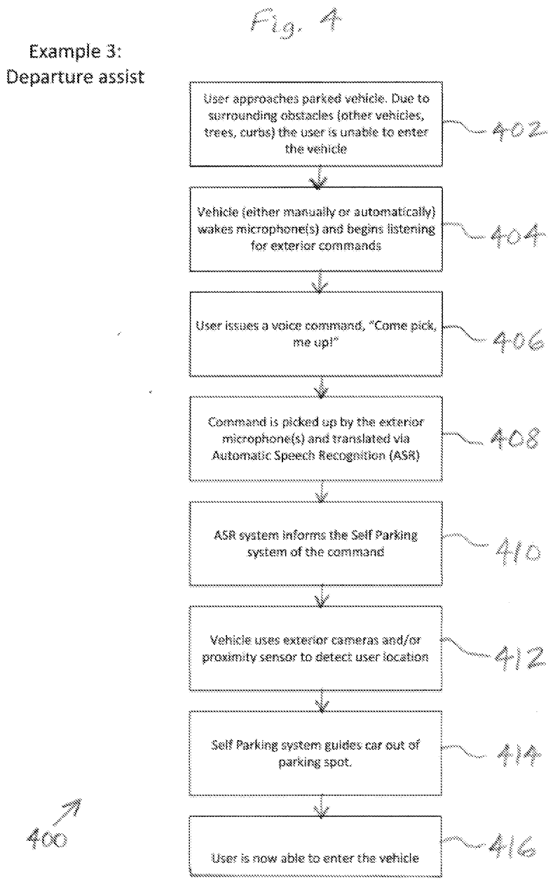

FIG. 4 illustrates yet another embodiment of a method 400 of the present invention for operating autonomous motor vehicle 10. In a first step 402, the user, possibly on foot, approaches a parked vehicle 10. Due to surrounding obstacles (e.g., other vehicles, trees, curbs) the user is unable to enter vehicle 10.

In step 404, vehicle 10 wakes microphone(s) 14a-b (either manually or automatically) and begins listening for exterior commands. For example, the driver may bring key fob 32 within a predetermined range of vehicle 10 to cause vehicle 10 to sense key fob 32 and then begin listening to microphones 14a-b. Alternatively, the driver may actuate a switch (not shown) on key fob 32 to cause ASR system 16 to begin listening to microphones 14a-b.

In a next step 406, the user speaks/issues a voice command, “Come pick, me up!”. Next, in step 408, the command is sensed/picked up by exterior microphone(s) 14a-b and translated or interpreted via Automatic Speech Recognition (ASR) system 16.

In step 410 ASR system 16 informs Self-Parking system 19 of the command. Next, in step 412, vehicle 10 uses exterior cameras 34 and/or a proximity sensor 40 to detect the user's location.

In a next step 414, Self-Parking system 19 guides and drives vehicle 10 out of the parking spot and to the detected location of the user. In a final step 416, the user is now able to enter vehicle 10 since vehicle 10 has been driven to his location.

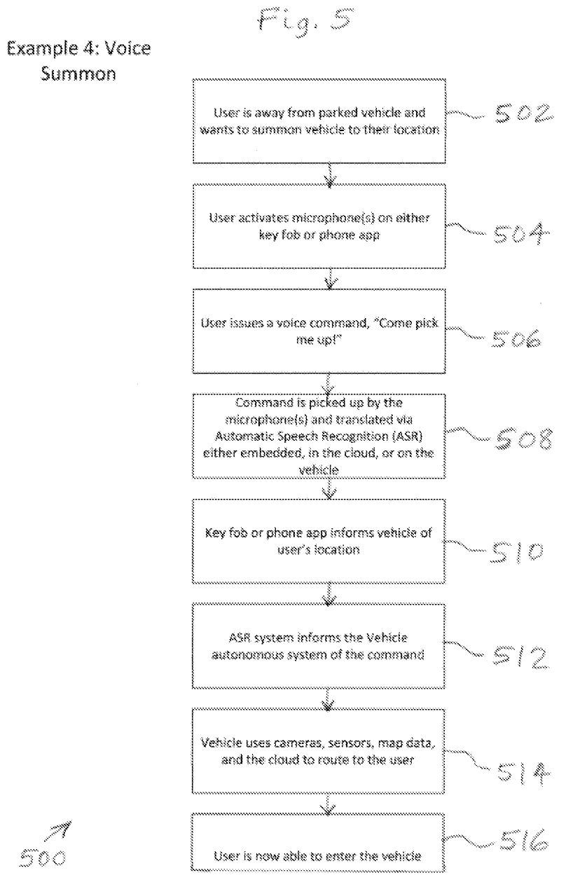

FIG. 5 illustrates a further embodiment of a method 500 of the present invention for operating autonomous motor vehicle 10. In a first step 502, the user is away from parked vehicle 10 and wants to summon vehicle 10 to their location.

Next, in step 504, the user activates either microphone 14c on mobile phone 30 or microphone 14d on key fob 32. For example, the user may press a button (not shown) on either phone 30 or key fob 32.

In a next step 506, the user issues a voice command, “Come pick me up!”. In step 508, the voice command is picked up by microphone 14c or microphone 14d and is translated or interpreted via Automatic Speech Recognition (ASR) system 16.

Next, in step 510, key fob 32 or an app running on mobile phone 30 informs vehicle 10 of the user's location. The location may be expressed in terms of global positioning system (GPS) coordinated, for example. In a next step 512, ASR system 16 informs autonomous parking system 19 of the command.

In step 514, autonomous parking system 19 uses GPS, cameras 34, sensors, map data, and cloud computers 18 to plan a route along which vehicle 10 travels to the location of the user. In a final step 516, the user is now able to enter vehicle 10, which has traveled to his location.

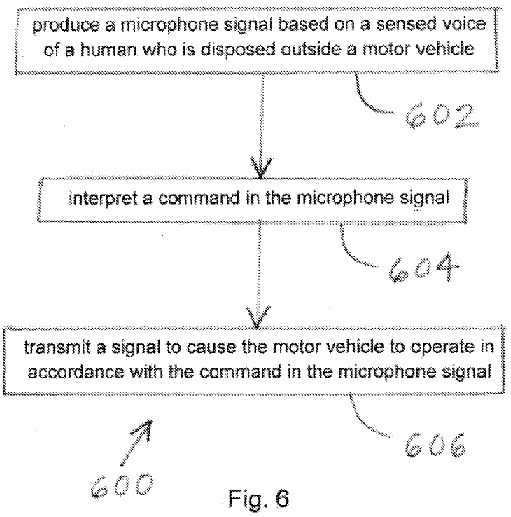

FIG. 6 illustrates one embodiment of a method 600 of the present invention for operating an autonomous motor vehicle. In a first step 602, a microphone signal is produced based on a sensed voice of a human who is disposed outside the motor vehicle. For example, microphone signals produced by microphones 14a-b may be based on voice commands spoken by the driver outside of vehicle 10 and sensed or picked up by microphones 14a-b.

Next, in step 604, a command in the microphone signal is interpreted. For example, ASR system 16 may interpret the command to determine its content (e.g., what command has been spoken).

In a final step 606, a signal is transmitted to cause the motor vehicle to operate in accordance with the command in the microphone signal. For example, ASR system 16 may transmit a signal informing self-parking system 19 of the command. Self-parking system 19 may then implement the command by use of vehicle driving system 25.

ASR system 16 has been described herein as being provided on board vehicle 10. However, it is also possible within the scope of the invention for the ASR system to be located in cloud computers 18 and accessed remotely by autonomous parking system 19.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A self-parking arrangement for an autonomous motor vehicle, the arrangement comprising:
a vehicle driving system configured to cause the motor vehicle to travel to a chosen or desired location;
a microphone positioned and configured to produce a microphone signal based on a sensed voice of a human who is disposed outside the motor vehicle; and
an automatic speech recognition system communicatively coupled to the microphone and configured to:
receive the microphone signal;
interpret a command in the microphone signal; and
transmit a second signal to cause the vehicle driving system to operate the motor vehicle in accordance with the command in the microphone signal.

2. The arrangement of claim 1 wherein the vehicle driving system includes:
a wheel steering system;
an engine/motor; and/or
a gear system.

3. The arrangement of claim 1 wherein the microphone is mounted on an exterior of a body of the motor vehicle.

4. The arrangement of claim 1 wherein the command is a command to park the motor vehicle in a parking space.

5. The arrangement of claim 1 wherein the command is a command to drive the motor vehicle out of a parking space.

6. The arrangement of claim 1 wherein the microphone is on a key fob.

7. The arrangement of claim 1 wherein the microphone is on a mobile telephone.

8. A method for operating an autonomous motor vehicle, the method comprising:
producing a microphone signal based on a sensed voice of a human who is disposed outside the motor vehicle;
interpreting a command in the microphone signal; and
transmitting a signal to cause the motor vehicle to operate in accordance with the command in the microphone signal.

9. The method of claim 8 wherein the signal is transmitted to cause a wheel steering system, an engine/motor, and/or a gear system of the motor vehicle to operate in accordance with the command in the microphone signal.

10. The method of claim 8 wherein the microphone signal is produced by a microphone mounted on an exterior of a body of the motor vehicle.

11. The method of claim 8 wherein the command is a command to park the motor vehicle in a parking space.

12. The method of claim 8 wherein the command is a command to drive the motor vehicle out of a parking space.

13. The method of claim 8 wherein the microphone signal is produced by a microphone included on a key fob.

14. The method of claim 8 wherein the microphone signal is produced by a microphone included on a mobile telephone.

15. A self-parking arrangement for an autonomous motor vehicle, the arrangement comprising:
a vehicle driving system configured to cause the motor vehicle to travel to a chosen or desired location;
a microphone positioned and configured to produce a microphone signal based on a sensed voice of a human who is disposed outside the motor vehicle; and
an automatic speech recognition system communicatively coupled to the microphone and configured to:
receive the microphone signal;
interpret a command in the microphone signal;
transmit the microphone signal to a remote computer;
receive a second signal from the remote computer, the second signal including an identification of the human and/or an authorization level of the human; and
transmit a third signal to cause the vehicle driving system to operate the motor vehicle in accordance with the command in the microphone signal, the third signal being dependent upon the identification of the human and/or the authorization level of the human.

16. The arrangement of claim 15 wherein the vehicle driving system includes:
a wheel steering system;
an engine/motor; and/or
a gear system.

17. The arrangement of claim 15 wherein the microphone is mounted on an exterior of a body of the motor vehicle.

18. The arrangement of claim 15 wherein the command is a command to park the motor vehicle in a parking space or to drive the motor vehicle out of a parking space.

19. The arrangement of claim 15 wherein the microphone is on a key fob or on a mobile telephone.

20. The arrangement of claim 15 wherein the automatic speech recognition system is configured to transmit the third signal only if the second signal from the remote computer indicates that the human is authorized to issue the command.
